(19) United States
(12) Patent Application Publication
(10) Pub. No.: US 2025/0329231 A1
(43) Pub. Date: Oct. 23, 2025

(54) INTEGRATED PRODUCT SURVEILLANCE SYSTEM USING EAS ANTENNA

(71) Applicant: CHECKPOINT SYSTEMS, INC., Thorofare, NJ (US)

(72) Inventors: Nimesh SHAH, Cherry Hill, NJ (US); Steve HOWELLS, Thorofare, NJ (US); Hernan YANOTTI, Terrassa (ES); Javier TAVIO, Terrassa (ES); Noe SALUDES, Canet de Mar (ES); Lucas Gassó FORTEZA, Sant Cugat del Valles (ES)

(21) Appl. No.: 18/870,737

(22) PCT Filed: May 31, 2023
(86) PCT No.: PCT/US2023/023973

§ 371 Date: Dec. 2, 2024

Related U.S. Application Data
(60) Provisional application No. 63/348,048, filed on Jun. 2, 2022.

(51) Int. Cl. G07G 3/00; E05B 73/00; H01Q 1/22

(52) U.S. Cl. CPC G07G 3/003; E05B 73/0017; H01Q 1/2216

(57) ABSTRACT

A EAS surveillance system is shown and described herein. The EAS surveillance system comprises a ferrite EAS antenna disposed adjacent a support surface of an area for surveillance. The EAS antenna is disposed in a substantially horizontal orientation relative to a ground surface. The EAS antenna can be surrounded or covered by a shroud to conceal the EAS antenna.

### CROSS-REFERENCE TO RELATED APPLICATIONS

This application claims priority to and the benefit of U.S. Provisional Application No. 63/348,048 filed on Jun. 2, 2022, which is incorporated herein by reference in its entirety.

### FIELD OF INVENTION

The present invention relates to a product surveillance system using an electronic article surveillance (EAS) antenna integrated into a physical structure of a surveillance area. In particular, the present invention provides a system employing an EAS antenna that allows for a reduced footprint of the antenna and/or the antenna being unnoticeable or substantially invisible to consumers.

### BACKGROUND

EAS antennas are known and used in a variety of applications for electronic surveillance of articles within a given environment. EAS antennas, for example, are sometimes placed at or near locations where they provide the greatest deterrent to theft such as at checkout counters (e.g., point of sale locations) or near the exit of a facility. Examples of such EAS antennas include EAS pedestal antennas that are placed near the exits of a facility such as a retail establishment.

Retailers also have an interest in employing EAS antennas at or near checkout counters. One option would be to employ an EAS pedestal in the checkout lane or against the checkout desk. These would be positioned downstream of the checkout desk, typically near the end of the checkout station (see, e.g., FIG. 1). EAS pedestals are often large structures, and their placement at the end of the checkout station—or even near the checkout station—may interfere with the customers during the checkout process reducing the ease of access to the collection area to bag or collect their items after purchase. EAS pedestals cannot be placed against metal counters, which may interfere with the field generated by the EAS pedestal and decrease the function of the EAS pedestal to accurately detect active tags. Further, the checkout station cannot be moved or relocated within a facility without having to move the EAS pedestals.

Other attempts have been made to integrate smaller profile EAS antennas at a checkout station. For example, flat panel EAS antennas have been incorporated into checkout systems. While smaller than EAS pedestals, the flat EAS antennas still have a relatively large surface area and can take up significant space within the checkout station. This may make concealing the flat EAS antenna more difficult. Using these flat EAS antennas may also require customization of the checkout station to allow accommodate the panels. Further, these types of antennas cannot be used with metallic checkout stations. While antennas do allow for concealment within the checkout station, the detection of the flat EAS antennas is generally limited to the height of the antenna. Many checkout stations have a height of around 80-110 cm, and the flat EAS antenna is usually positioned below the checkout counter. Consequently, the detection area when using the flat panels in this manner is limited to about waist level and below such that products with an active tag positioned above that height would not be detected.

Another prior solution has been to employ a tall vertical EAS antenna at the end of the checkout station. These vertical EAS antennas have a thinner profile than the pedestal antennas. While they take up less space in the checkout station than the EAS pedestals, they may still provide some interference to customers in the bagging or pickup area of the checkout station. Additionally, using these vertical EAS antennas requires drilling a hole in the checkout station to accommodate the EAS antenna. Metal checkout stations also impose a limitation on the detection sensitivity when using these vertical antennas.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a system for providing surveillance of items within a given area. The system employs an EAS antenna selected from a ferrite antenna disposed adjacent to a surface of a surveillance area, where the EAS antenna is positioned substantially horizontal to a ground surface. In one embodiment, the surface of the surveillance area comprises a shroud disposed on the surface of the surveillance area, and the EAS antenna is disposed within the shroud.

The use of a ferrite antenna disposed horizontally relative to a ground surface on a surface of a surveillance area has been found to provide excellent detection capabilities. The use of a ferrite antenna disposed in this matter has been found to provide a detection field that extends vertically such that the field can detect from near the ground surface to near shoulder height of a customer (e.g., about a 140 to about 180 cm detection zone from the lower end of the detection zone to the upper end of the detection zone).

Additionally, the present system provides good detection even when the surface of the surveillance area is formed from or includes a metal material.

The present system allows for concealment of an EAS antenna by a shroud such as, for example, a bumper, plastic cover, hollow molding, etc. Thus, the detection system can be used in a variety of locations where surveillance may be desirable including, but not limited to, checkout stations, exit areas, walls in corridors such as in areas of breakrooms, bathrooms, etc.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is a prior art system showing pedestal EAS antennas;

FIG. 2 is an embodiment of a surveillance area comprising the present EAS system;

FIG. 3 is an embodiment of a surveillance area comprising the present EAS system;

FIG. 4 is a side view of a checkout station employing the EAS detection system;

FIG. 5 is a perspective view of the checkout station of FIG. 4;

FIG. 6 is an end view of the checkout station of FIGS. 4 and 5;

FIG. 7a-7d represents a method of inserting an EAS antenna into a bumper of a checkout station;

FIG. 8a is a plot of the EAS tag pick up rate for the EAS antenna configuration of FIG. 8b;

FIG. 9a is a plot of the EAS tag pick up rate for the EAS antenna configuration of FIG. 9b;

FIG. 10a is a plot of the EAS tag pick up rate for the EAS antenna configuration of FIG. 10b;

FIG. 11a is a plot of the EAS tag pick up rate for the EAS antenna configuration of FIG. 11b;

FIG. 12a is a plot of the EAS tag pick up rate for the EAS antenna configuration of FIG. 12b; and

FIG. 13a is a plot of the EAS tag pick up rate for the EAS antenna configuration of FIG. 13b.

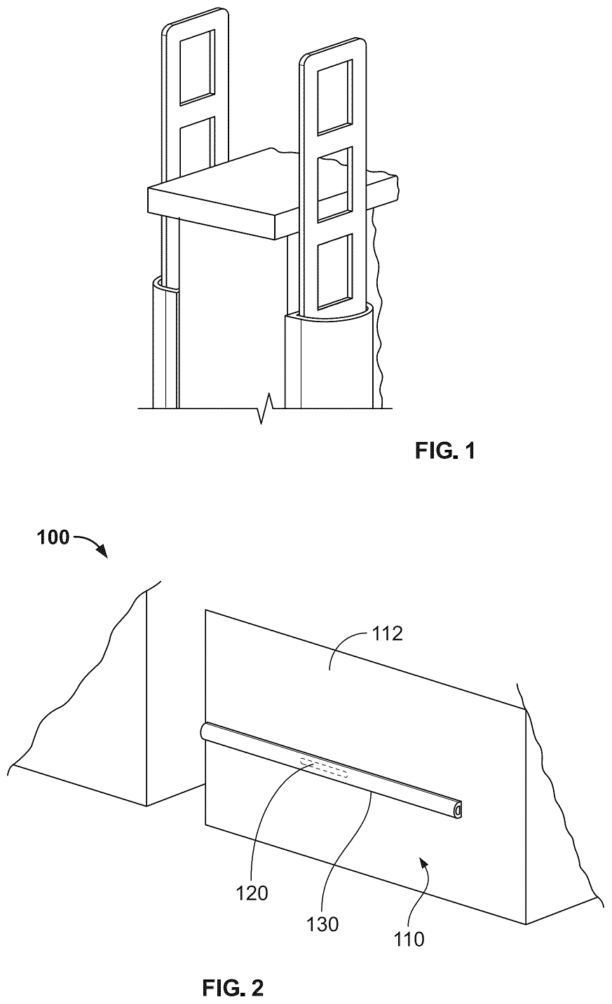

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a surveillance system for detecting active EAS tags, and passive tags that have not been deactivated or detached within a given area. The system employs an EAS antenna selected from a ferrite antenna disposed adjacent to a surface of a surveillance area, where the EAS antenna is positioned substantially horizontal to a ground surface. In one embodiment, the surface of the surveillance area comprises a shroud disposed on the surface of the surveillance area, and the EAS antenna is disposed within the shroud.

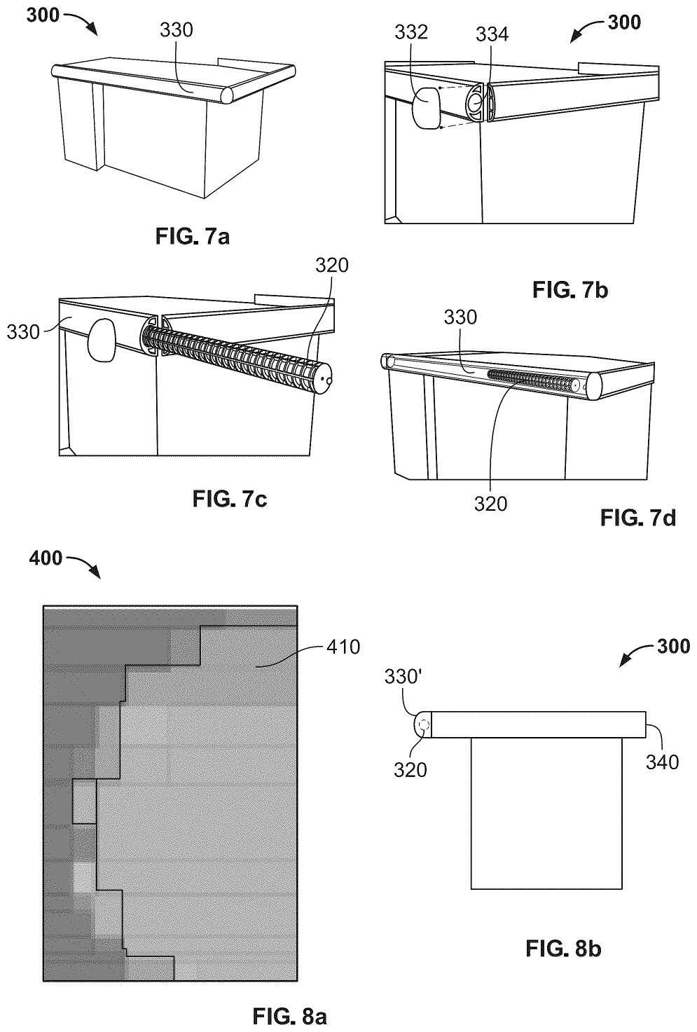

FIG. 2 illustrates a surveillance area 100 in the location of a hallway or corridor that includes a wall 110 defining a surface 112 that is substantially vertical relative to the ground surface. The EAS system includes an EAS antenna 120 selected from a ferrite antenna disposed adjacent to the surface 112 of the wall 110. The EAS antenna 120 is oriented parallel to the ground surface. The EAS antenna 120 is surrounded by a shroud 130 that is disposed on the surface 112 of wall 110. The shroud defines a space into which the EAS antenna 120 may be disposed. The space may simply be a void in which the EAS antenna simply sits in and rests against a portion of the shroud and/or surface. The space within the shroud may contain a designated cavity sized and shaped for receiving the EAS antenna. For example, as shown in FIGS. 7b and 7c, the space within the shroud includes a molded cavity for receiving the shroud.

The shroud could be configured as desired to allow access to the EAS antenna. The shroud may be a multi-piece structure with a section mounted on the surface of interest and a piece that clips on the mounted piece to define the interior space and surround an EAS antenna. In another embodiment, the shroud can be a formed structure with a removable section to expose the interior space of the shroud. The removable section can be positioned anywhere on the shroud as desired for a particular purpose or intended application. The removable section depending on its location would be sized to allow for insertion or removal of the EAS antenna from the interior space. In one embodiment, as shown in FIGS. 7b and 7c, the removable piece is provided as a removable cap at an end of the shroud.

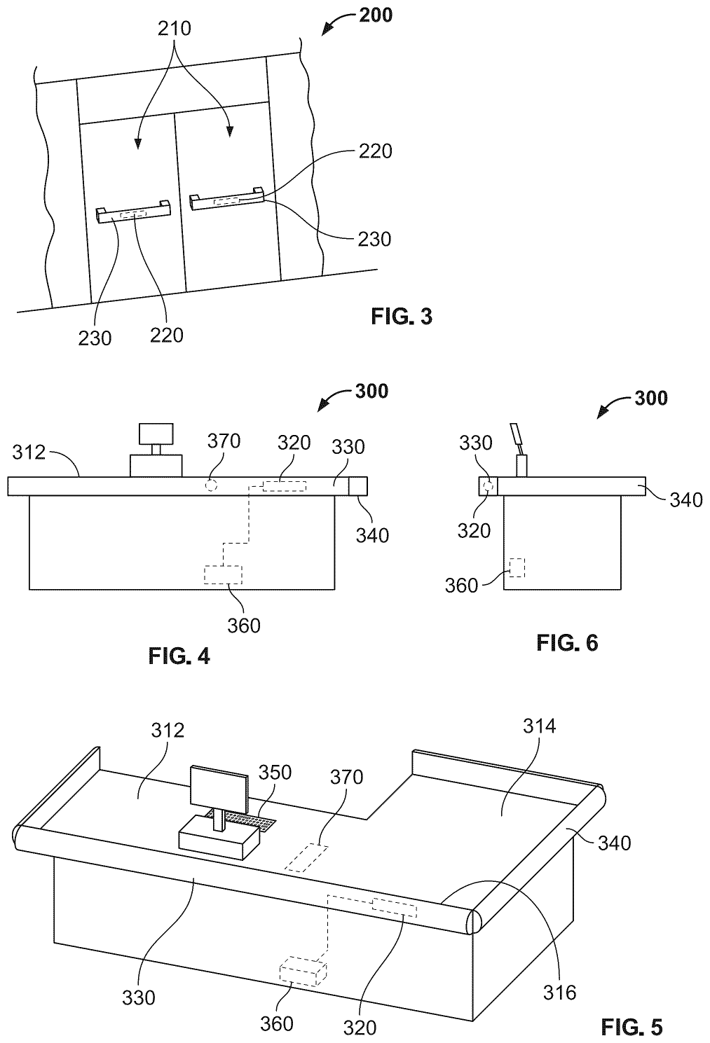

FIG. 3 illustrates an embodiment of a surveillance area 200 provided by doors 210 defining a surface 212. An EAS antenna is disposed adjacent to the surface of the doors 210. The EAS antenna is oriented horizontal to a ground surface. The EAS antenna is surrounded by a shroud 230. In this embodiment the shroud can be provided directly adjacent to the surface of the door or it may be slightly offset relative to the surface of the door and be disposed in a shroud that forms a handle or push bar on the door.

FIGS. 4-6 illustrate an embodiment of a surveillance area 300 comprising a checkout station. The checkout station includes a checkout desk 310 that includes a product loading area 312 where products are loaded for scanning at checkout, a product receiving area 314 where products are moved after being scanned, and a scanning area 350 where products are scanned into the system for checking out. The scanning area includes a reader to read the product coding information that identifies the product and record the item for sale. The scanning area typically also includes a device to remove and deactivate security tags associated with the product being scanned.

The checkout desk 310 includes a surface 316 adjacent the upper end of the checkout desk and oriented toward the customer side of the checkout desk. The checkout desk includes a shroud 330 adjacent the top end of the checkout desk providing a cavity into which an EAS antenna 320 is disposed. The system includes an electronic device and power supply 360 to provide power to the EAS antenna and connect the antenna to an alarm system (not shown). Security tags that have not been deactivated (and/or removed from a product) would be detected by the EAS antenna 320 as a customer carrying such a product or a product whose tags have not been removed or deactivated are moved toward the EAS antenna.

When the surveillance system is employed with a checkout system, the EAS antenna is located downstream of the scanning/reader station to avoid or decrease the occurrence of active tags from the product loading area being prematurely detected prior to being scanned or deactivated. In one embodiment, the EAS antenna is placed at least 50 cm away from the scanner to avoid incorrectly detecting live tags that are in the loading area or in the process of being scanned. In the embodiment shown in FIGS. 4-6, the system includes an inhibitor antenna 370 disposed between the scanning area and the EAS antenna 320 that would block the signal from the EAS antenna 320 and/or any tags up field toward the scanning area to avoid improper detection of live tags.

The EAS antenna employed in the present system is a ferrite or magnetic material core with windings disposed about ferrite core. The windings can include windings to form a resonant circuit and windings to allow electrically isolated output that can be connected to an electronic article surveillance receiver. The shape of the ferrite core is not particularly limited. In embodiments, the circumference of the ferrite core can be rectangular, circular, oblong, etc. The ferrite can be covered with a housing, e.g., a plastic cover, which surrounds and protects the ferrite core.

The length of the EAS antenna can be selected as desired for a particular purpose or intended application. Longer antennas may provide more coverage zone along the length of the antenna. The size of the antenna may be based on the location in which the antenna is used. For example, the antenna size may be restricted based on the available area of the location where the antenna is used. If placed on a wall, the antenna size may not be so restricted as compared to employing at a checkout station or in a door area. In one embodiment, the EAS antenna has a length of 30 cm or more. In one embodiment, the EAS antenna has a length of 30 cm to 100 cm, 40 cm to 90 cm, 50 cm to 80 cm, or 60 cm to 70 cm.

The use of the ferrite antenna has been found to provide excellent detection when placed adjacent a vertical surface of a surveillance area. Without being bound to any particular theory, the antenna field is believed to rotate around the ferrite core. In this way, the field can get “around” the core. As such, the EAS antenna field is not blocked in the desired direction of detection even if the surface to which the EAS antenna is adjacent is a metal surface.

FIGS. 7a-7d illustrate an embodiment of providing the EAS antenna to a surveillance system. In FIGS. 7a-7d an EAS antenna is provided to a checkout station system 300 that includes a shroud 330 in the form of a bumper that covers the EAS antenna. The bumper includes a cap 332 that is removed from an end of the bumper 330 to expose a cavity 334 for receiving the EAS antenna. The EAS antenna is inserted into the cavity 334 and the cap 332 is then restored to its position on the bumper 330 to cover the cavity such that the EAS antenna is concealed within the bumper 330.

A shroud or cover with a removable end may be desirable to allow for easier removal and replacement of an EAS antenna (should it malfunction and need to be replaced with a new antenna). Alternatively, the EAS antenna could be part of a pre-formed cover piece that is provided prior to placement of the cover piece to the surface of interest (checkout station, wall, etc.) The shroud can be formed from any material as may be desired for an intended use or application with the exception that the shroud is generally not a metallic material. The shroud can be formed from a polymeric material, wood, and the like. In one embodiment, the shroud is formed from a plastic material. In one embodiment, the shroud is formed from a rubber material. The hardness or impact resistance of the shroud can be selected as desired for a particular purpose or intended application.

EAS antennas were tested for their ability to detect EAS tags when placed at different positions on a checkout counter station. For each arrangement, the detection field of the EAS antenna relative to three different types of surveillance tags is shown. Three different tags were evaluated. The tags employed for testing were an adjustable bottle collar (adjustable bottle collar, super, RF) available from Checkpoint Systems, Inc., a needle lock hard tag (bottle tag round LG SPL 8.2 MHZ) from Checkpoint Systems, Inc., and a 410 EP soft tag (label) from Checkpoint Systems, Inc. FIGS. 8-13 show the positions of the antennas on the checkout counter and the mixed results of the pick rate for the three tags. The pick rate represents the system performance and how well the system can detect an EAS tag in the detection area. The checkout station employed was a station with an upper shelf area made of metal and includes a bumper along the length of the station (running along the checkout lane) and a bumper at the end of the station (along the width of the station). The height of the detection area measured is 180 cm and the length is 110 cm for each of the readings.

### Examples

In FIG. 8, the checkout system employed was in accordance with the present invention wherein an EAS antenna was disposed within a bumper as depicted in FIGS. 4-7. The EAS antenna was a round ferrite 35 cm in length. The plot 400 (FIG. 8a) shows the detection field with the EAS antenna disposed in the bumper. The area 410 indicates a pick rate of about 75% or greater.

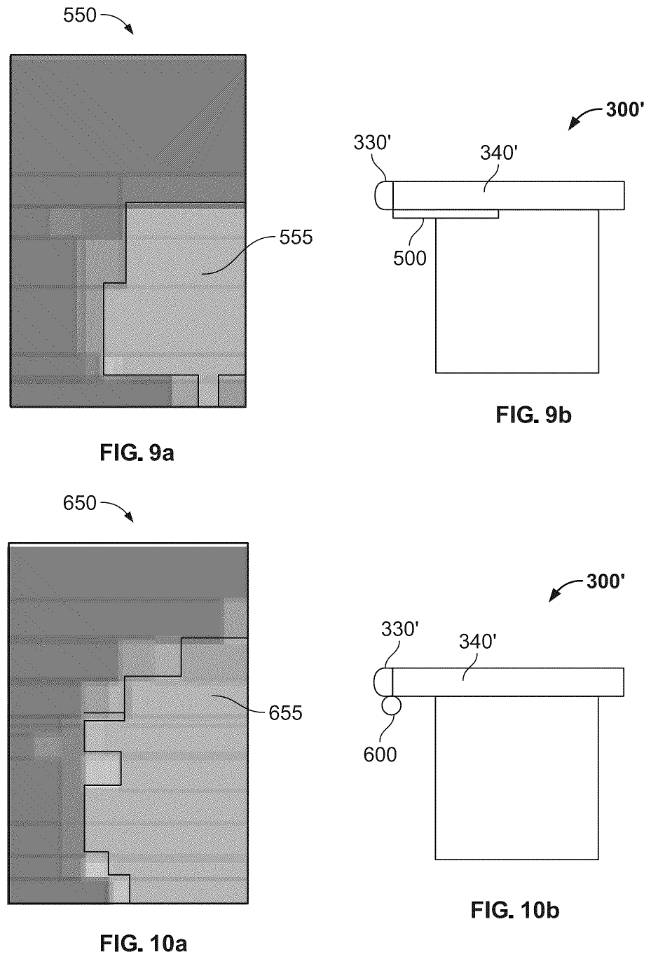

FIGS. 9-13 evaluate a surveillance area 300′ that is similar in all aspects to the checkout station 310 except that the EAS antenna is not disposed within the bumper 330′ or 340′. In FIG. 9, circular EAS antenna 500 with a length of 60 cm was disposed underneath the shelf and below the bumper at the end of the checkout station along the width of the station. As shown in detection field 550, detection levels of 75% or greater are achieved in area 555. That area is significantly reduced compared to that of FIG. 8 and is particularly poor above what would be waist level of a customer. This may be due to interference from the metal of the shelf.

In FIG. 10, an EAS antenna 600 with a length of 30 cm was employed and positioned under the shelf at the end of the shelf and along the length of the shelf in the checkout lane (FIG. 10b). The detection field plot 650 (FIG. 10a) shows an area 655 with a pick rate of 75% or greater. While somewhat better than the configuration in FIG. 9, the arrangement in FIG. 10 still shows a reduced pick rate compared to FIG. 8. Without being bound to any particular theory, this may be due to interference from the metal shelf.

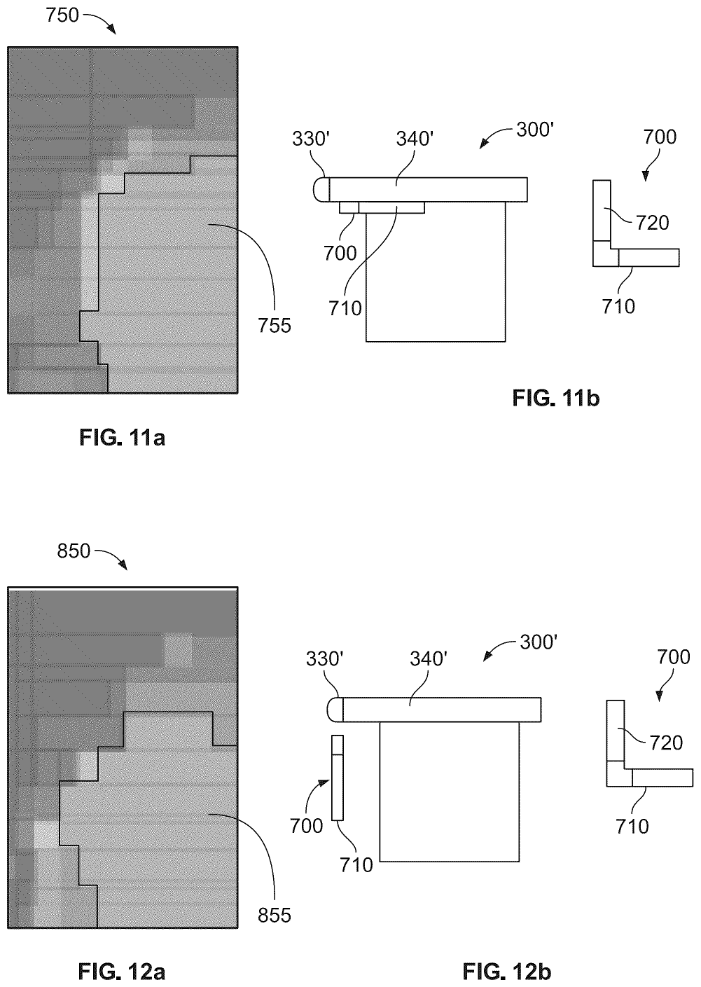

FIG. 11 employs an EAS antenna 700 with an angular construction comprising arms 710 and 720. The arms 710 and 720 are 30 cm in length. The EAS antenna 700 is disposed underneath the shelf such that the arm 710 is disposed at the end of the station and runs along width of the station, and the arm 720 runs along the length of the station (FIG. 11b). The detection field plot 750 (FIG. 11a) shows an area 755 with a pick rate greater than 75%. The area 755 is similar to that of area 655. Again, the reduced detection area may be due to interference of the field from the metal shelf.

In FIG. 12, the EAS antenna 700 is oriented such that arm 720 is disposed along the length of the checkout station (as in FIG. 11) and arm 710 is oriented vertically downward from the shelf (FIG. 12b). The detection field plot 850 (FIG. 12a) shows an area 855 where the pick rate is 75% or greater. As with the configurations of FIGS. 10 and 11, the metal of the shelf may be interfering with the field of the EAS antenna above the shelf.

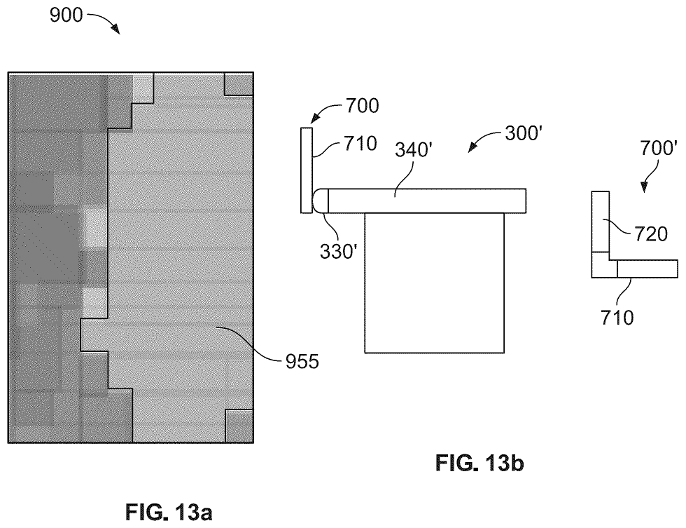

In FIG. 13, the EAS antenna 700 is disposed on the side of the bumper 330 with the arm 710 oriented vertically upward from the counter and the arm 720 disposed along the length of bumper 330 (FIG. 13b). Detection field plot 900 (FIG. 13a) shows an area 955 where the pick rate is 75% or greater. The area 955 extends substantially from the floor to the upper end of the detection area (180 cm). In this instance, the wider vertical range of detection may indicate that the EAS antenna field is not impeded by the metal of the shelf.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an EAS surveillance system. Modifications may occur to those skilled in the art and to those who may make and use the invention. The disclosed embodiments are merely for illustrative purposes and not intended to limit the scope of the invention or the subject matter set forth in the claims.

1. An EAS surveillance system comprising an EAS antenna disposed adjacent to a surface oriented vertically relative to a ground surface; where the EAS antenna is selected from a ferrite antenna and the EAS antenna is disposed substantially horizontal relative to the ground surface.

2. The EAS surveillance system of claim 1 comprising a shroud disposed on the surface, the shroud defining an interior space surrounding the EAS antenna.

3. The EAS surveillance system of claim 2, wherein the shroud comprises a cavity defined in the interior space for receiving the EAS antenna.

4. The EAS surveillance system of claim 2, wherein the shroud comprises a removable section for providing access to the interior space of the shroud.

5. The EAS surveillance system of claim 4, wherein the removable section is a removable cap positioned at an end of the shroud.

6. The EAS surveillance system of claim 1, wherein the vertically oriented surface is a wall.

7. The EAS surveillance system of claim 1, wherein the vertically oriented surface is a door.

8. The EAS surveillance system of claim 1, wherein the vertically oriented surface is a portion of a checkout station.

9. A checkout station comprising:
an upper shelf area having a first end, a second end opposite the first end, a first customer side, and a second sales clerk side, and a EAS tag deactivator disposed between the first end and the second end;
the customer side defining a surface vertically oriented relative to a ground surface; and
an EAS antenna disposed adjacent the surface of the customer side, the EAS antenna selected from a ferrite antenna and being disposed horizontal relative to the ground surface between the EAS tag deactivator and the second end.

10. The checkout station of claim 9, comprising a shroud surrounding the EAS antenna.

11. The checkout station of 9, wherein the shroud defines an interior space into which the EAS antenna is disposed.

12. The checkout station of claim 11, wherein the shroud comprises a removable section for providing access to the interior space of the shroud.

13. The checkout station of claim 12, wherein the removable section is a removable cap positioned at an end of the shroud.

14. The checkout station of claim 11, wherein the shroud comprises a cavity defined in the interior space for receiving the EAS antenna.

15. The checkout station of claim 14, wherein the shroud comprises a removable cap covering the cavity.

16. The checkout station of claim 10, wherein the shroud is a bumper rail disposed adjacent an upper end of the shelf area.

17. The checkout system of claim 9, wherein the EAS antenna is at least 50 cm away from the tag deactivator.
